(19) United States
(12) Patent Application Publication
(10) Pub. No.: US 2025/0298458 A1
(43) Pub. Date: Sep. 25, 2025

(54) SYSTEMS AND METHODS FOR CONTROLLING POWER CONSUMPTION IN AN ELECTRONIC GAMING ENVIRONMENT

(71) Applicant: Aristocrat Technologies, Inc., Las Vegas, NV (US)

(72) Inventors: Rolland Steil, Las Vegas, NV (US); Eric Taylor, Carson City, NV (US); Xiaoqiang Gong, Henderson, NV (US); Anthony Patton, Las Vegas, NV (US); Alexander Coulthard, Las Vegas, NV (US); Alvin Chen, Las Vegas, NV (US); Stephen Shaffer, JR., Las Vegas, NV (US); James Connell, Las Vegas, NV (US); Rodney Slade, Las Vegas, NV (US)

(21) Appl. No.: 18/890,115

(22) Filed: Sep. 19, 2024

Related U.S. Application Data
(60) Provisional application No. 63/568,787, filed on Mar. 22, 2024.
(60) Provisional application No. 63/568,949, filed on Mar. 22, 2024.
(60) Provisional application No. 63/568,796, filed on Mar. 22, 2024.
(60) Provisional application No. 63/568,947, filed on Mar. 22, 2024.

(51) Int. Cl. G06F 1/3234; G06F 1/3231; G07F 17/32

(52) U.S. Cl. CPC G06F 1/325; G06F 1/3231; G07F 17/3227; G07F 17/3237

(57) ABSTRACT

A system for power consumption management for an electronic gaming environment includes at least one memory device with instructions stored thereon. The at least one memory device further storing a plurality of energy profiles, each of the energy profiles defining a set of control operations for at least one electronic gaming device. The system further includes at least one processor in communication with the at least one memory device. The instructions, when executed by the at least one processor, cause the at least one processor to receive a power adjustment command, select, based on the power adjustment command, a first energy profile of the plurality of energy profiles, and control the at least one electronic gaming device to adjust power consumption based on the first energy profile.

### CROSS-REFERENCE TO RELATED APPLICATIONS

This application claims priority to U.S. Provisional Patent Application Nos. 63/568,787, 63/568,949, 63/568,796, and 63/568,947, each of which was filed Mar. 22, 2024, the disclosures of which are hereby incorporated by reference in their entireties.

### TECHNICAL FIELD

The field of disclosure relates generally to smart grids applied in an electronic gaming environment, and more specifically, to controlling power consumption in an electronic gaming environment based on grid commands.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In some cases, a player may qualify for a special mode of the base game, a secondary game, or a bonus round of the base game by attaining a certain winning combination or triggering event in, or related to, the base game, or after the player is randomly awarded the special mode, secondary game, or bonus round. In the special mode, secondary game, or bonus round, the player is given an opportunity to win extra game credits, game tokens or other forms of payout. In the case of “game credits” that are awarded during play, the game credits are typically added to a credit meter total on the EGM and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Typical games use a random number generator (RNG) to randomly determine the outcome of each game. The game is designed to return a certain percentage of the amount wagered back to the player over the course of many plays or instances of the game, which is generally referred to as return to player (RTP). The RTP and randomness of the RNG ensure the fairness of the games and are highly regulated. Upon initiation of play, the RNG randomly determines a game outcome and symbols are then selected which correspond to that outcome. Notably, some games may include an element of skill on the part of the player and are therefore not entirely random.

### BRIEF DESCRIPTION

In one aspect, a system for power consumption management for an electronic gaming environment is provided. The system includes at least one memory device with instructions stored thereon, the at least one memory device further storing a plurality of energy profiles, each of the energy profiles defining a set of control operations for at least one electronic gaming device. The system further includes at least one processor in communication with the at least one memory device. The instructions, when executed by the at least one processor, cause the at least one processor to receive a power adjustment command, select, based on the power adjustment command, a first energy profile of the plurality of energy profiles, and control the at least one electronic gaming device to adjust power consumption based on the first energy profile.

In another aspect, a non-transitory computer-readable medium is provided. The medium is readable by a processor and includes instructions stored thereon that, when executed, cause the processor to receive a power adjustment command and select, based on the power adjustment command, a first energy profile of a plurality of energy profiles stored on the medium. Each of the energy profiles define a set of control operations for at least one electronic gaming device. The instructions further cause the processor to control the at least one electronic gaming device to adjust power consumption based on the first energy profile.

In yet another aspect, a method for managing power consumption of a gaming device is provided. The method includes receiving a power adjustment command and selecting, based on the power adjustment command, a first energy profile of a plurality of energy profiles. Each of the energy profiles defines a set of control operations for the gaming device. The method further includes controlling the gaming device to adjust power consumption based on the first energy profile.

### BRIEF DESCRIPTION OF THE DRAWINGS

FIG. 1 is an exemplary diagram showing several EGMs networked with various gaming related servers.

FIG. 2A is a block diagram showing various functional elements of an exemplary EGM.

FIG. 2B depicts a casino gaming environment according to one example.

FIG. 2C is a diagram that shows examples of components of a system for providing online gaming according to some aspects of the present disclosure.

FIG. 3 illustrates, in block diagram form, an implementation of a game processing architecture algorithm that implements a game processing pipeline for the play of a game in accordance with various implementations described herein.

FIG. 4 illustrates an exemplary power consumption management system for an electronic gaming environment according to an embodiment of the present disclosure.

FIG. 5 illustrates an exemplary communication network for use with the power consumption management system of FIG. 4.

FIG. 6 illustrates another communication network for use with the power consumption management system of FIG. 4.

FIG. 7 illustrates another communication network for use with the power consumption management system of FIG. 4.

FIG. 8 is a flowchart illustrating a first example process power consumption management, which may be performed by the power consumption management system shown in FIG. 4.

FIG. 9 is a flowchart illustrating a second example process power consumption management, which may be performed by the power consumption management system shown in FIG. 4.

FIG. 10 is a flowchart illustrating a third example process power consumption management, which may be performed by the power consumption management system shown in FIG. 4.

FIG. 11 is a flowchart illustrating a fourth example process power consumption management, which may be performed by the power consumption management system shown in FIG. 4.

### DETAILED DESCRIPTION

Described herein are systems and methods for controlling power consumption in an electronic gaming environment. A local and/or cloud-based server may be in communication with one or more gaming devices and/or other electronic devices within the electronic gaming environment. This system may include a memory that stores a plurality of energy profiles, each of the energy profiles defining a set of control operations that reduce power consumption in the electronic gaming environment. For example, each energy profile may be associated with a certain reduction in power consumption (e.g., a ten percent reduction, a twenty percent reduction, etc.).

Some examples of control operations for reducing power consumption may include deactivating and/or placing in a low-power (i.e., “sleep”) mode certain gaming devices and/or other devices (e.g., lighting), deactivating and/or placing in a low-power mode certain peripheral devices of the gaming devices (e.g., bill validators and/or printers), deactivating, dimming, or adjusting a duty cycle of lighting (i.e., having a light source be lit some fraction of a second), adjusting (e.g., dimming or at least partially turning off) signage of the gaming devices, adjusting displays of gaming devices (e.g., substituting default display outcomes with less energy intense display outcomes, such as ones including fewer animations or static displays), identifying zones (e.g., those with lower occupancy) of the electronic gaming environment in which certain power reduction actions can be taken, and/or other actions that reduce power consumption.

In one exemplary embodiment, the system may select one of the energy profiles under which to operate the electronic gaming environment based on a power reduction command. This power reduction command may be received from an external source, such as a smart grid system and/or utility company, and/or may be generated internally based on, for example, input from a system operator and/or determinations made by the system. Based on the power reduction command, the system may select an energy profile that meets the requirements of the power reduction command. For example, if the power reduction command specifies that power consumption needs to be reduced by twenty percent, the system may select an energy profile that results in a twenty percent reduction in power consumption.

In another exemplary embodiment, the system may select one of the energy profiles under which to operate the electronic gaming environment using a predictive model. The system may retrieve current data relating to the electronic gaming environment (sometimes referred to herein as “site data”), and the predictive model may select an energy profile based on the site data factoring in various data such as a current availability of power, a current need for power (e.g., based on an occupancy of the electronic gaming environment), expectations of players currently present in the electronic gaming environment, and/or any other factors that may influence power consumption and/or capabilities of the electronic gaming environment to reduce power consumption while providing a desirable gameplay experience. The predictive model may be, for example, a machine learning and/or artificial intelligence model trained based upon historical site data, historical power consumption data, and/or any other feedback resulting from past control operations executed to reduce power consumption.

A technical problem exists in reducing power consumption of electronic gaming sites. The system described herein solves this technical problem by dynamically controlling devices within an electronic gaming site based on energy profiles, which are selected based on current needs of the system. As described above, the energy profile may be selected based on a power reduction command and/or a predictive model that defines a relationship between certain control operations of the energy profiles and expected outcomes. Accordingly, an overall power consumption of the electronic gaming site may be reduced while still enabling the electronic gaming site to provide a satisfactory experience to customers.

The technical problems addressed herein include: (i) inability of known systems to predict the impact of power consumption reduction controls for one or more gaming devices on user engagement with gaming devices; (ii) inability of known systems to identify power consumption reduction controls that achieve a desired power consumption reduction while maintaining an optimal user engagement; and (iii) inability of known systems to automatically control a plurality of gaming devices using different power consumption reduction controls to achieve an overall desired power consumption reduction.

The resulting technical effect and/or technical benefits achieved herein include at least one of: (i) ability to predict the impact of power consumption reduction controls for one or more gaming devices on user engagement with gaming devices; (ii) ability to identify power consumption reduction controls that achieve a desired power consumption reduction while maintaining an optimal user engagement; and (iii) ability to automatically control a plurality of gaming devices using different power consumption reduction controls to achieve an overall desired power consumption reduction.

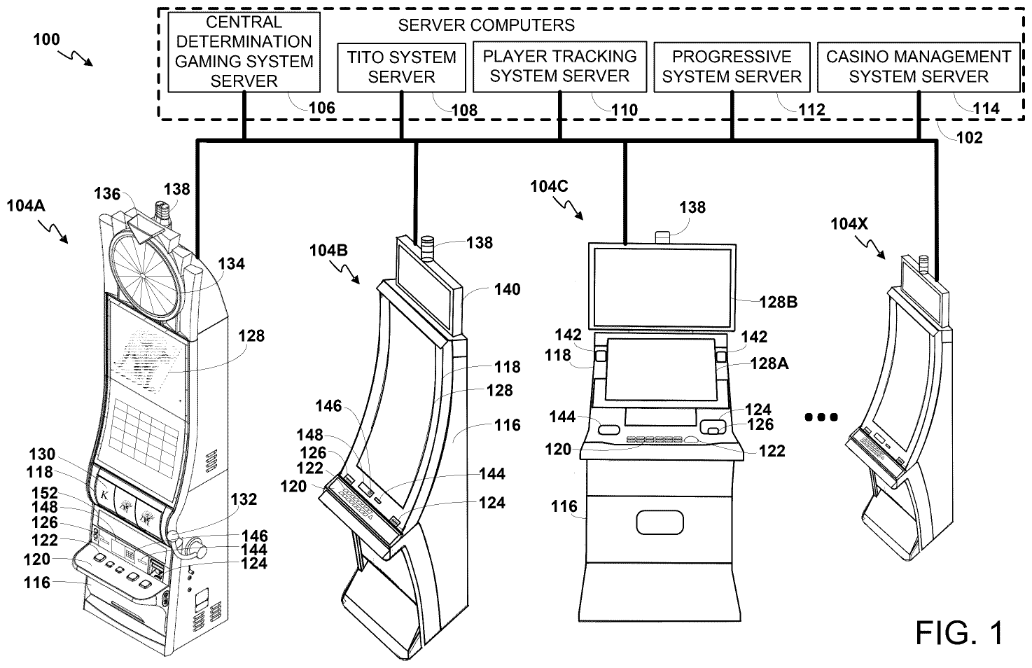

FIG. 1 illustrates several different models of EGMs which may be networked to various gaming related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi®) and Bluetooth®), cable TV, satellite links and the like.

In some implementation, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player's smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

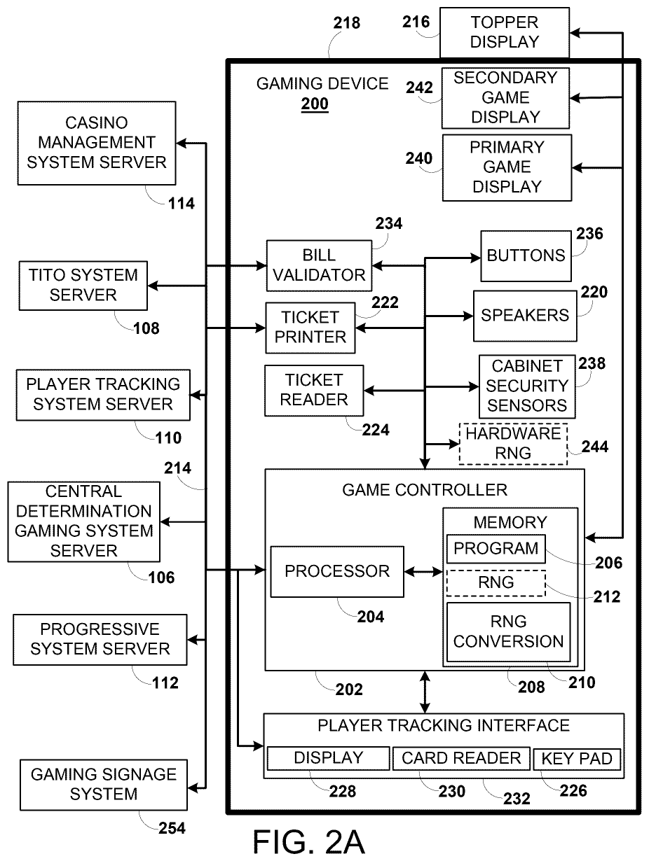

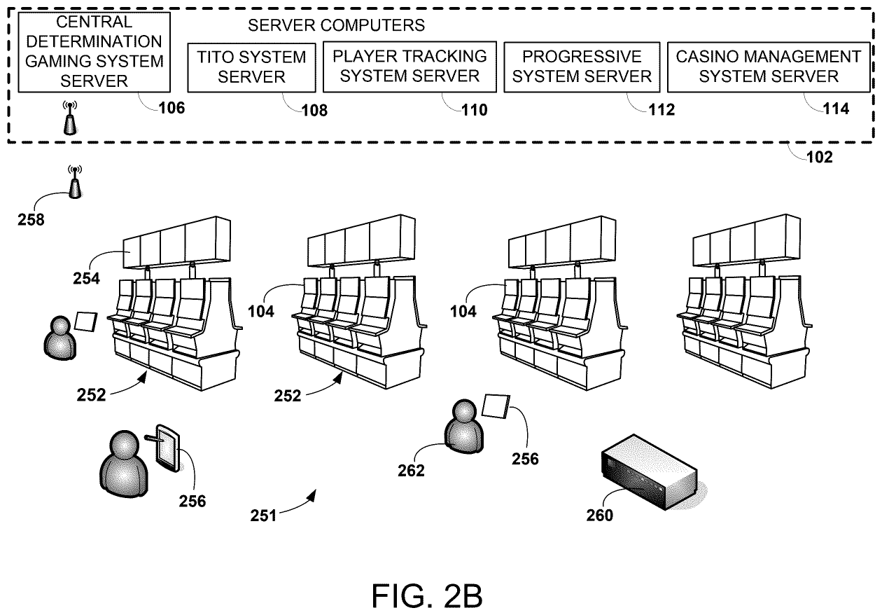

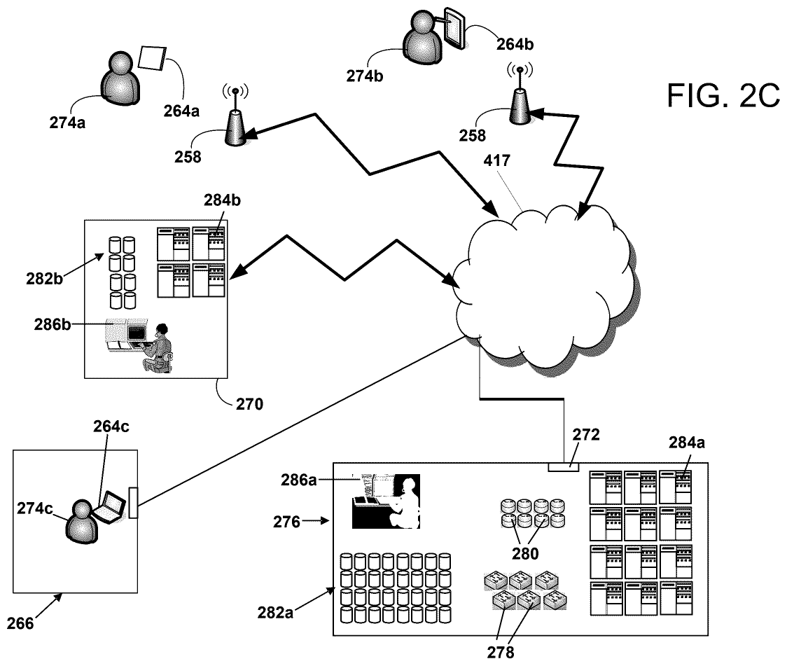

Many or all the above described components can be controlled by circuitry (e.g., a game controller) housed inside the main cabinet 116 of the gaming device 104A, the details of which are shown in FIG. 2A.

An alternative example gaming device 104B illustrated in FIG. 1 is the Arc™ model gaming device manufactured by Aristocrat® Technologies, Inc. Note that where possible, reference numerals identifying similar features of the gaming device 104A implementation are also identified in the gaming device 104B implementation using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary game play while secondary display 128B is typically used for bonus game play, to show game features or attraction activities while the game is not in play or any other information or media desired by the game designer or operator. In some implementations, example gaming device 104C may also include speakers 142 to output various audio such as game sound, background music, etc.

Many different types of games, including mechanical slot games, video slot games, video poker, video black jack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2 also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random access memory (SRAM), dynamic random access memory (DRAM), magnetic random access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS® system manufactured by Aristocrat® Technologies, Inc. Player tracking system server 110 is used to track play (e.g. amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs, the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen, or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 2B depicts a casino gaming environment according to one example. In this example, the casino 251 includes banks 252 of EGMs 104. In this example, each bank 252 of EGMs 104 includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming according to some aspects of the present disclosure. As with other figures presented in this disclosure, the numbers, types and arrangements of gaming devices shown in FIG. 2C are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 286a. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

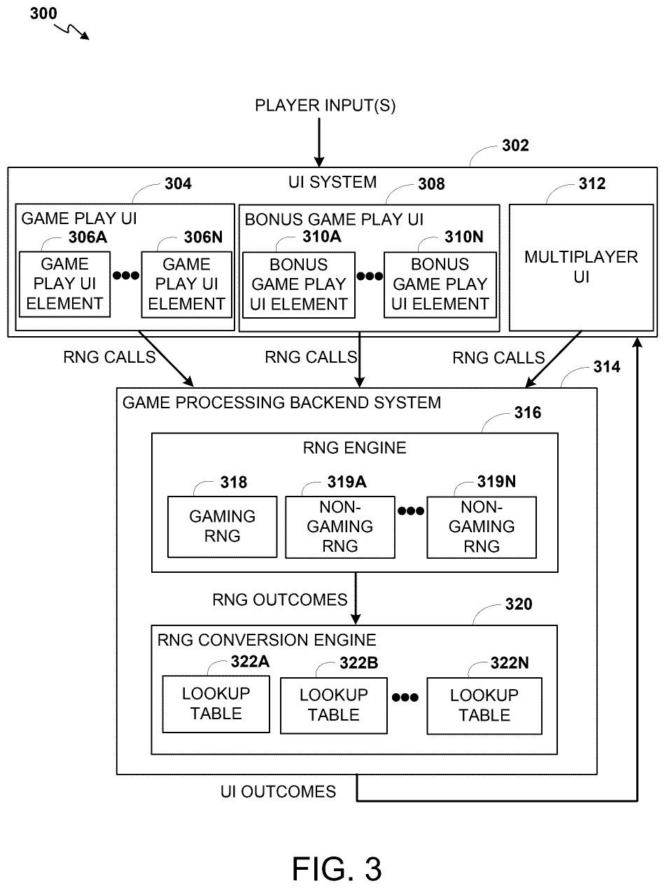

FIG. 3 illustrates, in block diagram form, an implementation of a game processing architecture 300 that implements a game processing pipeline for the play of a game in accordance with various implementations described herein. As shown in FIG. 3, the gaming processing pipeline starts with having a UI system 302 receive one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1.

The UI system 302 includes one or more UIs that a player can interact with. The UI system 302 could include one or more game play UIs 304, one or more bonus game play UIs 308, and one or more multiplayer UIs 312, where each UI type includes one or more mechanical UIs and/or graphical UIs (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 3 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more virtual reels) are shown and/or made available to a user. In a subsequent game instance, the UI system 302 could transition out of the base game to one or more bonus games. The bonus game play UI 308 represents a UI that utilizes bonus game play UI elements 310A-310N for a player to interact with and/or view during a bonus game. In one or more implementations, at least some of the game play UI element 306A-306N are similar to the bonus game play UI elements 310A-310N. In other implementations, the game play UI element 306A-306N can differ from the bonus game play UI elements 310A-310N.

FIG. 3 also illustrates that UI system 302 could include a multiplayer UI 312 purposed for game play that differs or is separate from the typical base game. For example, multiplayer UI 312 could be set up to receive player inputs and/or presents game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player's gaming experience, tournament mode can modify and synchronize sound, music, reel spin speed, and/or other operations of the gaming devices according to the tournament game play. After tournament game play ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N. Gaming RNG 318 could corresponds to RNG 212 or hardware RNG 244 shown in FIG. 2A. As previously discussed with reference to FIG. 2A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 2A). Alternatively, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 2A, RNG conversion engine 320 corresponds to RNG conversion engine 210 used for game play. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more game play UI elements 306A-306N, such as symbols, for the game play UI 304. In another example, if the UI outcome is for a bonus game, the UI system could update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline.

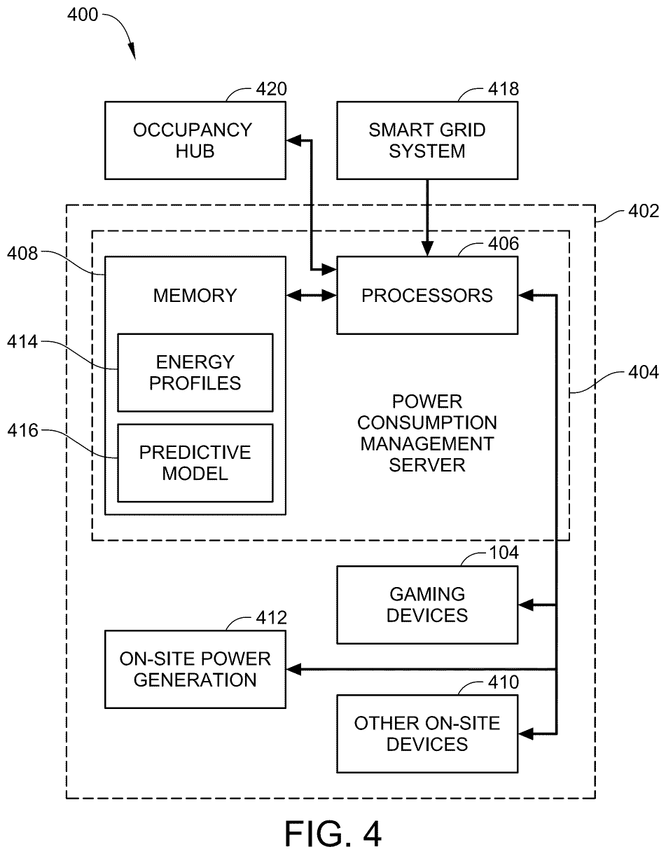

FIG. 4 is a block diagram of an exemplary power consumption management system 400 for an electronic gaming environment 402 (e.g., a casino or other location with a group of gaming devices 104). Power consumption management system 400 may include a power consumption management server 404, which includes at least one processor 406 and at least one memory 408. As shown in FIG. 4, power consumption management server 404 may be implemented as a server within gaming environment 402 (e.g., incorporated with player tracking system server 110). Additionally, or alternatively, power consumption management server 404 may be implemented using one or more remote and/or cloud computing devices in communication with player tracking system server 110. As described in further detail below, power consumption management server 404 may be configured to communicate with (e.g., using EGM/casino communication protocols such as SAS, G2S, S2S, etc.) and control the power consumption of gaming devices 104 and/or other on-site devices 410 (e.g., lighting and/or air conditioning systems, server computers 102, etc.) of electronic gaming environment 402. In some embodiments, electronic gaming environment 402 may also include local or regional on-site or off-site power generation 412 (e.g., solar power systems), which may be in communication with and provide data to power consumption management server 404.

In the exemplary embodiment, memory 408 may store a plurality of energy profiles 414 that each include a set of control operations that reduce power consumption in electronic gaming environment 402. These control operations may include, for example, deactivating and/or placing in a low-power (i.e., “sleep”) mode certain gaming devices 104 and/or other on-site devices 410, deactivating and/or placing in a low-power mode certain peripheral devices of gaming devices 104 (e.g., bill validator 124, printer 126, and/or any other auxiliary devices of gaming devices 104), deactivating, dimming, or adjusting a duty cycle of lighting (i.e., having a light source be lit some fraction of a second), adjusting (e.g., dimming or at least partially turning off) signage of gaming devices 104, adjusting displays of gaming devices 104 (e.g., substituting default display outcomes with less energy intense display outcomes, such as ones including fewer animations or static displays), identifying zones (e.g., those with lower occupancy) of electronic gaming environment 402 in which certain power reduction actions can be taken, and/or other ways of reducing power. For example, power consumption management server 404 may be capable of communicating directly with peripheral devices such as bill validator 124 and/or printer 126 to control these devices to enter a low-power or sleep mode, and/or may communicate with a power management device of gaming device 104 instructing the power management device to place bill validator 124 and/or printer 126 in a low-power or sleep mode.

In various exemplary embodiments, examples of devices and/or aspects within gaming environment 402 that may be controlled may include: (1) a monitor and/or backlighting brightness of gaming devices 104; (2) an LED brightness of gaming devices 104; (3) a quantity of LEDs of gaming devices 104 that are illuminated (e.g., illuminating every other or every third LED instead of every LED); (4) audio and/or amplifier levels of gaming devices 104; (5) graphics resolution of gaming devices 104 or other displays; (6) graphics layering of gaming devices 104 or other displays; (7) deactivating or putting into a sleep mode bill validators 124; (8) deactivating or putting into a sleep mode printers 126; (9) throttling, placing into a sleep mode, adjusting a processing speed or other performance characteristics of a CPU of gaming devices 104; (10) de-energizing stepper motors; (11) deactivating or reducing a brightness or volume of signage and/or media players; (12) load smoothing; (13) adjusting a variable frequency power supply; (14) deactivating or putting into a sleep mode player tracking systems or portions thereof; (15) deactivating or putting into a sleep mode progressive jackpot systems or portions thereof; (16) dimming or shutting off ambient lighting; and/or (17) deactivating a certain percentage of gaming devices 104.

Each of energy profiles 414 may identify specific gaming devices 104 and/or other on-site devices 410 to be controlled and specific control operations for each of the identified specific gaming devices 104 and/or other on-site devices 410. Each energy profile may also be associated with a certain amount of power consumption reduction. For example, a first energy profile 414 may be associated with a ten percent reduction, a second energy profile 414 may be associated with a twenty percent reduction, and so on. Additionally, in some embodiments, on-site power generation 412 may be controlled based on energy profiles 414. For example, energy profiles 414 associated with lesser degrees of power consumption reduction may enable some power generated by on-site power generation 412 to be exported from electronic gaming environment 402, while energy profiles 414 associated with lesser degrees of power consumption reduction may require that all power produced by on-site power generation 412 be used on-site. As describe in further detail below, processor 406 may select one of energy profiles 414 to implement based on the power consumption reduction requirements of electronic gaming environment 402.

Additionally or alternatively, one or more of the energy profiles 414 may be associated with a same or a similar amount of reduction in power consumption, but may control gaming devices 104 and/or other on-site devices 410 differently to achieve the reduction in power consumption. As an example, in one embodiment, a first energy profile may achieve an overall ten percent reduction in power consumption by controlling a subset of gaming devices 104 to enter a sleep mode, in which the main display 240 is inactive or otherwise operating at a reduced power level as described herein. Additionally, a second energy profile may achieve the same overall ten percent reduction in power consumption by controlling a larger subset of gaming devices 104 to perform a lesser power reduction, such as by dimming edge lighting or topper display 216.

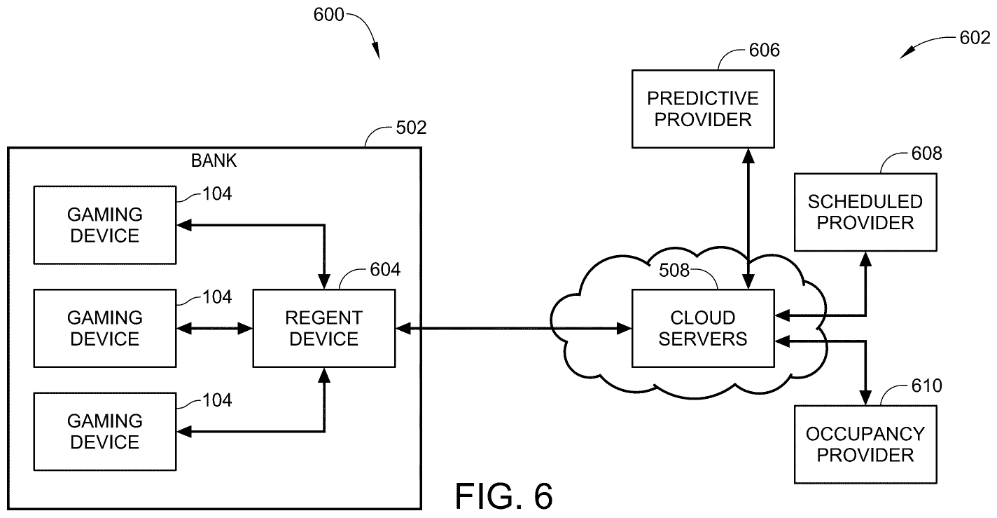

In some embodiments, energy profiles 414 includes a first set of energy profiles (also referred to herein as “power level energy profiles”) that are associated with a power consumption level and a second set of energy profiles that are associated with control operations for devices 104, 410 based on the selected power consumption level (also referred to herein as “device control energy profiles”). As an example, the power level energy profiles may include the power consumption levels (e.g., a high power level, a 10% reduced power level, a 20% reduced power level, etc.) and the second set of energy profiles may provide command instructions for devices 104, 410 to achieve the selected power consumption level. In some embodiments, the power level energy profiles are stored at power consumption server 404 and the device control energy profiles are stored on a memory of the devices 104, 410 or another remote device, such as regent device 604 (see FIG. 6).

In the exemplary embodiment, memory 408 may further store a predictive model 416. Predictive model 416 may be, for example, a machine learning and/or artificial intelligence model configured to select an appropriate energy profile 114 and/or corresponding amount of power consumption reduction based on data (referred to herein as “site data”) relating to electronic gaming environment 402. Some site data may be retrieved from gaming devices 104, other on-site devices 410 (e.g., sensors located in electronic gaming environment 402), player tracking system server 110, and/or external sources (e.g., the Internet). This site data may include, for example, a current time (e.g., of day, week, or year), current weather and/or temperature, current occupancy of electronic gaming environment 402, current occupancy of any hotels, restaurants, parking structures, and/or other businesses associated with electronic gaming environment 402, whether any events (e.g., shows, concerts, sporting events, and/or conventions) are scheduled near electronic gaming environment 402, a current amount of power available from on-site power generation 412, and/or any other types of data that may relate to power consumption of electronic gaming environment 402 and/or outcomes of reducing a power consumption of electronic gaming environment 402 (e.g., whether such changes may be noticed by patrons of electronic gaming environment 402).

In the exemplary embodiment, system 400 further includes an occupancy hub 420 that collects site data indicating an external occupancy event (i.e., an event external to the gaming environment and/or the casino floor) and provides the external occupancy event site data to the server 404. Example external occupancy event data may include an occupancy of any hotels, restaurants, parking structures, and/or other businesses associated with electronic gaming environment 402, whether any events (e.g., shows, concerts, sporting events, and/or conventions) are scheduled near electronic gaming environment 402. The external occupancy event site data may be captured by one or more external sensors, such as proximity sensors, parking space occupancy sensors, or ingress/egress sensors in a parking garage or casino entry/exit doors, video and/or audio capture devices, sensors detecting elevator calls/movement, door ingress/egress, image recognition of security video, audio sensors detecting a noise level in and/or around casino, vehicle traffic monitoring sensors, and/or data traffic monitoring of a wireless network. Additionally or alternatively, the external occupancy event data may include scheduled event data, such as a schedule for a nearby concert and/or a schedule of casino events, such as a tournament, giveaway event, a conference hosted at the casino, or any other suitable casino event likely to impact casino floor occupancy.

Predictive model 416 may be trained based on historical site data and associated outcomes, such as historical power consumption data, and historical execution of control operations to reduce power consumption. Predictive model 416 may be further trained based on user engagement data received from one or more of the gaming devices 104 that indicates user engagement with the gaming devices when operated according to one or more of the energy profiles. The user engagement data may include gameplay data, such as bet amounts, number of game plays, length of gaming sessions by individual users, etc. that are provided from the gaming devices 104 to the server 404. The user engagement data may also include feedback from customers and/or operators, floor data such as number of entries/exits to/from the casino floor, and/or other factors that may be influenced by such site data and/or execution of control operations to reduce power consumption. In some embodiments, this user engagement data may be retrieved from a large number of electronic gaming environments 402. Predictive model 416 may be generated by processor 406 and/or periodically downloaded from an external source, and be periodically and/or continually updated with new training data.

Predictive model 416 may be configured to identify conditions under which it may be possible and/or desirable to reduce power consumption while providing a positive player experience. For example, if at Time A, a first category of players are present at a certain group of gaming devices 104 that show a stronger preference of games that include a large number of animations, and at Time B, a second category of players are present at that group of gaming devices 104 that are generally indifferent to an amount of animations displayed during gameplay, predictive model 416 may determine that an energy profile 414 that enables all animations at that group of gaming devices 104 can be selected at Time A, and an energy profile 414 that reduces some or all animations can be selected at Time B. Accordingly, the players present at Time A may enjoy the full amount of animations, while power consumption may be reduced at Time B, reducing the amount of animations and thereby reducing an overall power consumption.

Predictive model 416 may be configured to generate estimates of how certain energy profiles 414, and/or variations in reduction of overall power consumption, affect player experience by comparing one or more of user engagement data, site data, and historical data under the different energy profiles 414. For example, predictive model 416 may generate an estimate that a first energy profile during current site conditions (e.g., time of day, weather, etc.) is likely to lead to a first amount of player engagement reduction (e.g., as represented in a reduction of cumulative player bets and/or reduced player time at gaming devices 104) and that a second energy profile during the same site conditions is likely to lead to a second different amount of player engagement reduction.

Predictive model 416 may be further configured to identify optimal energy profiles for one or more gaming devices 104, according to the generated predictions, that will maximize user engagement with gaming devices. As an example, predictive model 416 may predict, based on the above-described training, that a first energy profile, which reduces screen brightness for three of every four gaming devices 104 in a bank while inactive, is likely to lead to a 10% reduction in overall bets from the bank of devices 104 during a certain time of day. In the same example, predictive model 416 may further predict that a second energy profile, which achieves the same power reduction by reducing a refresh rate of all displays, is likely to lead to only a 5% reduction in overall bets during the same time. Accordingly, predictive model 416 may determine that the second energy profile is an optimal energy profile to achieve the given power reduction and, in some instances, may automatically control the second bank of devices to operate according to the second energy profile.

Predictive model 416 may be trained based on historical site data and associated outcomes, such as historical power consumption data, historical execution of control operations to reduce power consumption, feedback from customers and/or operators, and/or other factors that may be influenced by such site data and/or execution of control operations to reduce power consumption. In some embodiments, this historical data may be retrieved from a large number of electronic gaming environments 402. Predictive model 416 may be generated by processor 406 and/or periodically downloaded from an external source, and be periodically and/or continually updated with new training data.

In various exemplary embodiments, examples of data that may be used to train predictive model 416 and/or may be used by predictive model 416 to select an energy profile 414 may include: (1) parking occupancy; (2) scheduled or detected arrival of busses and how many passengers are disembarking; (3) event schedules; (4) monitoring door ingress/egress; (5) number of wagering credits currently present on games; (6) monitoring table game occupancy and minimum bet levels; (7) data from proximity sensors (e.g., those used to control ambient lighting); and/or (8) utility demand.

In the exemplary embodiment, power consumption management server 404 may be further in communication with a smart grid system 418, which may be associated with a utility company or other entity responsible for supplying power to electronic gaming environment 402. Smart grid system 418 may transmit a power reduction command to power consumption management server 404. For example, the power reduction command may specify that power consumption needs to be reduced by some percentage (e.g., ten percent, twenty percent, etc.). Additionally, or alternatively, a power reduction command may be generated internally with respect to electronic gaming environment 402 (e.g., based on input from an operator or a determination made by power consumption management server 404). In response to receiving the power reduction command, power consumption management server 404 may select an energy profile 414 that meets the requirements of the power reduction command. For example, if a power reduction command specifies that power consumption needs to be reduced by ten percent, power consumption management server 404 may select an energy profile 414 that, when implemented, results in a ten percent reduction in power consumption.

In some cases, power consumption management server 404 may determine (e.g., based on site data) that it is not feasible to meet the requirements of the power reduction command. For example, a certain minimum amount of power may be necessary to support the current level of activity at electronic gaming environment 402. Additionally or alternatively, one or more of gaming devices 104 may transmit a signal to the server 404, indicating that the gaming device 104 is not in a suitable operating mode to reduce power. As one example, when a gaming device 104 is in use, the device 104 may generate and transmit a signal to the server 404 indicating that it is currently in use. In such cases, power consumption management server 404 may select an energy profile 414 that reduces power consumption as much as is feasible. In some embodiments, server 404 may not reduce power, or may reduce power to a lesser extent, to those gaming devices 104 that are presently in use. Power consumption management server 404 may transmit data to smart grid system 418 indicating a reduction in power consumption that was successfully accomplished. In the event of an unsuccessful power reduction, server 404 may perform one or more additional operations, such as generating an alert, indicating that the power reduction is unsuccessful and/or notifying an operator of the casino to take additional power control measures, such as switching to a backup power source to avoid a power outage.

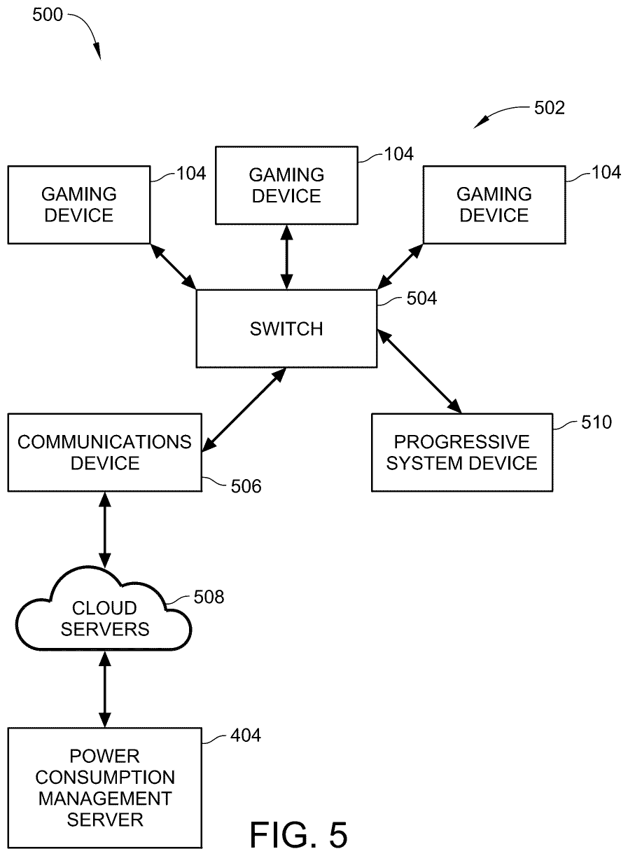

FIG. 5 is an exemplary embodiment of a communications network 500 for providing two-way communications between gaming devices 104 and server 404. Communication network 500 includes a bank 502 of gaming devices 104, a network switch 504, a communications device 506, one or more “cloud-based” servers 508 (alternatively referred to herein as “cloud servers”), and power consumption management server 404. In the example embodiment each of gaming devices 104 are in communication with a switch 504, that facilitates data transmissions to and from gaming devices 104 and to cloud servers 508, via communications device 506. In other embodiments, one or more of gaming devices 104 may include a dedicated communications device 506 that provides communication between gaming devices 104 and cloud servers 508 (i.e., without the use of switch 504).

In the exemplary embodiment, communications device 506 is configured for two-way communications with a network switch 504 and cloud servers 508. Communications device 506 may collect and/or receive collected data related to operations of gaming devices (e.g., via switch 504) including, power consumption data, operational state of components of gaming devices, fault data, gaming data, etc. Communications device 506 is also configured to transmit commands (e.g., received from server 404) for controlling one or more components or operations of gaming device 104. Communications device 506 may include one or more of an API client, a data collector, an internet of things (“IOT”) device, a Game to System (“G2S”) device, a modem, or any other device that is configured to operate as described herein. Communication device 506 is configured to communicate with cloud servers 508 by one or more wireless networks, such as a Wi-Fi network or cellular data network. Cloud servers 508 may include an API server 404 and a data store (alternatively a “data lake”) that stores data collected from gaming devices 104.

In other embodiments, each gaming device 104 may include a communications device 506 that communicates with server 404 through cloud servers 508 and/or to switch 504. Communications device 506 may be integrated into gaming devices 104 and/or switch 504 or may be a separate component that is installed into gaming device 104 and/or switch 504. In other embodiments, communications network 500 may include a bridge device (not shown) for relaying communications between cloud servers 508 and communications device 506. For example, in one embodiment, one or more of gaming devices includes an IOT device coupled thereto that is configured to collect data from the gaming devices and transmit the data to switch 504. In some such embodiments a modem (not shown) is coupled to switch 504 and facilitates transmitting the collected data received from gaming devices to cloud servers 508.

In the exemplary embodiment, communications network 500 further includes a progressive system device 510 in two-way communication (wired or wireless) with switch 504. Progressive system device 510 is configured to control a progressive jackpot award game that is applied to each of gaming devices 104 in bank 502. Progressive system device 510 may include any one or more of a progressive controller, a progressive server (similar to progressive system server 112), and/or a progressive switch. In some embodiments, power management server 404 is configured to transmit instructions to switch 504 which controls progressive system device 510 to perform power reduction operations as described herein. For example, in one embodiment, one or more of energy profiles 414 may include instructions which cause progressive system device 510 to power down and/or otherwise operate at a reduced level of power consumption. The instructions may be conditional on whether one or more players are at gaming devices 104 and/or a minimum number of players are presently playing for the progressive jackpot.

FIG. 6 is an exemplary embodiment of an alternative communications network 600 for use with the power consumption management system 400, shown in FIG. 4. Communications network 600 is substantially the same as communications network 500, shown in FIG. 5, except as otherwise described differently herein.

In the exemplary embodiment, network 600 includes a plurality of providers 602 (alternatively referred to herein as “data providers”), which collectively function in a substantially similar manner as the power consumption management server 404, shown in FIG. 5. Providers 602 may be stored on a single server (i.e., similar to server 404, shown in FIG. 5) or may be stored across one or more different servers and/or controllers.

In the exemplary embodiment, network 600 includes a regent device 604 (alternatively referred to herein as a “data subscriber”) providing two-way communications between each of the gaming devices 104 with the cloud servers 508 and providers 602. The regent device 604 is an internet of things (“IOT”) device configured for communication with gaming devices 104 using EGM/casino communication protocols such as SAS, G2S, S2S, etc. In the exemplary embodiment, the regent device 604 is a G2S listener and includes an on-board controller (not shown). In some embodiments, regent device 604 is substantially the same as communications device 506, shown in FIG. 5. The regent device 604 may be in communication with cloud servers 508 via a wireless network (e.g., wi-fi and/or cellular network).

Network 600 is a cloud-based provider model that serves as the decision maker for power consumption of gaming devices 104. The data providers 602 provide instructions to the gaming devices 104 indicating which energy profiles 414 the gaming devices 104 should be set to. In the exemplary embodiment, data providers 602 include a predictive provider 606, a scheduled provider 608, and an occupancy provider 610. The predictive provider 606 may be substantially the same as the predictive model 416, providing predictive analytics that support machine learning of play patterns within the gaming environment. The scheduled provider 608 provides days and times that a casino determines are appropriate for different power profiles. The occupancy provider 610 provides occupancy monitoring, e.g., of the casino floor, parking structures, elevators, and other occupancy data described herein to provide real time information for power consumption decisions. In some embodiments, regent device 604 includes an analytic extension (e.g., added to G2S messages), providing a generic communication method to receive data from gaming devices 104.

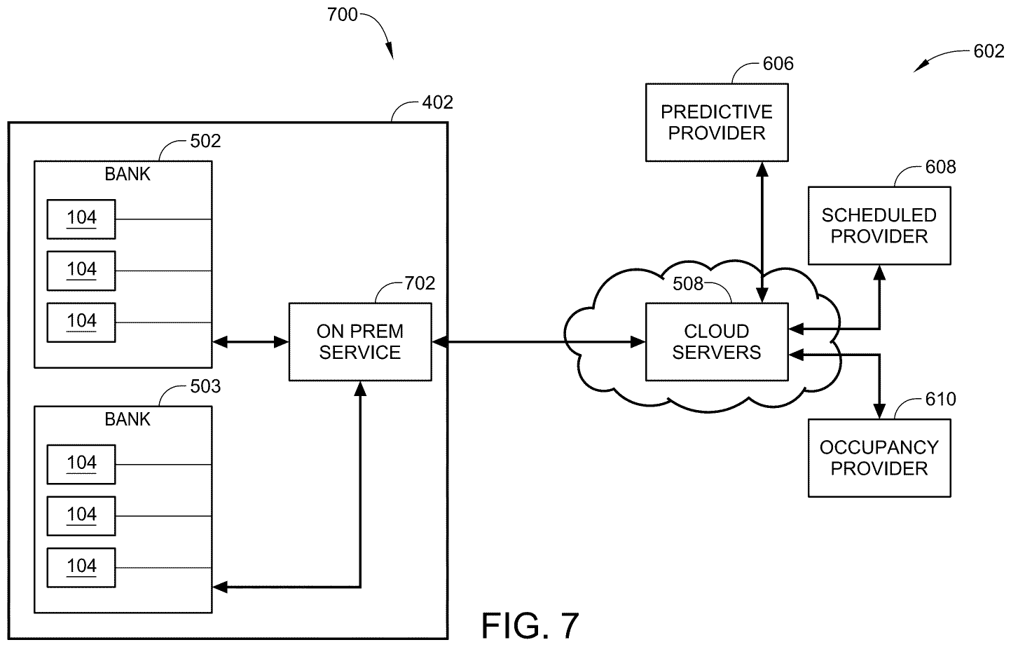

FIG. 7 is an exemplary embodiment of another alternative communications network 700 for use with the power consumption management system 400, shown in FIG. 4. Communications network 700 is substantially the same as communications network 600, shown in FIG. 6, except as otherwise described differently herein. In particular, in the example embodiment, network 700 does not include regent device 604 and instead includes an on-premises service device 702. The on-premises service device 702 provides communication between cloud servers 508 and gaming devices 104 of a plurality of banks 502, 503 within a gaming environment 402 (e.g., a floor of a casino). The on-premises service device 702 is configured for communication with gaming devices 104 using EGM/casino communication protocols such as SAS, G2S, S2S, etc.

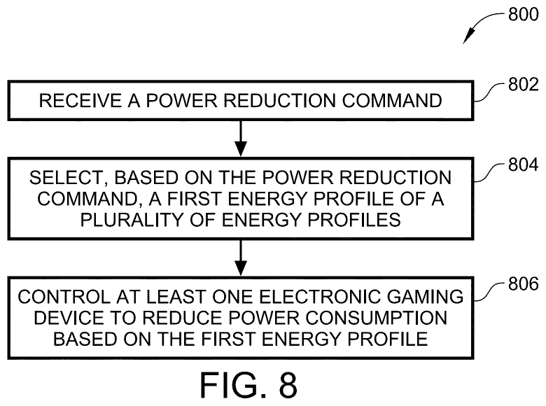

FIG. 8 is a flowchart illustrating an exemplary process 800 for power consumption management for an electronic gaming environment such as electronic gaming environment 402. Process 800 may be performed by power consumption management server 404 of power consumption management system 400 (shown in FIG. 4).

In the exemplary embodiment, process 800 may include receiving 802 a power reduction command. The power reduction command may be received from an external source, such as smart grid system 418, or be generated internally. The power reduction command may specify a target amount of power reduction, such as a percentage (e.g., ten percent, twenty percent, etc.).

In the exemplary embodiment, process 800 may further include selecting 804, based on the power reduction command, a first energy profile 414 of a plurality of energy profiles 414. As described above, energy profiles 414 may identify specific gaming devices 104 and/or other on-site devices 410 to be controlled and specific control operations for each of the identified specific gaming devices 104 and/or other on-site devices 410 that cause gaming devices 104 and/or other on-site devices 410 to reduce power consumption. Each energy profile may also be associated with a certain amount of power consumption reduction. For example, if a power reduction command is received specifying that a ten percent reduction in power is needed, an energy profile 414 corresponding to a ten percent reduction in power may be selected.

In the exemplary embodiment, process 800 may further include controlling 806 at least one electronic gaming device 104 and/or other on-site device 410 to reduce power consumption based on the first energy profile. For example, the first energy profile may specify that certain control operations be performed, including for example, deactivating and/or placing in a low-power (i.e., “sleep”) mode certain gaming devices 104 and/or other on-site devices 410, deactivating and/or placing in a low-power mode certain peripheral devices of gaming devices 104 (e.g., bill validator 124, printer 126, and/or any other auxiliary devices of gaming devices 104), deactivating, dimming, or adjusting a duty cycle of lighting (i.e., having a light source be lit some fraction of a second), adjusting (e.g., dimming or at least partially turning off) signage of gaming devices 104, adjusting displays of gaming devices 104 (e.g., substituting default display outcomes with less energy intense display outcomes, such as ones including fewer animations or static displays), identifying zones (e.g., those with lower occupancy) of electronic gaming environment 402 in which certain power reduction actions can be taken, and/or other ways of reducing power. Performing the control operations specified by the first energy profile may result in the reduction in power consumption specified by the power reduction command.

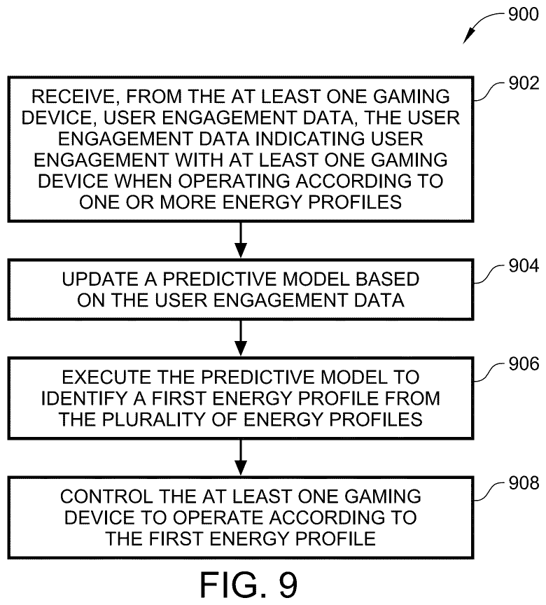

FIG. 9 is a flowchart illustrating an exemplary process 900 for power consumption management for at least one gaming device, such as one of gaming devices 104 (shown in FIG. 4). Process 900 may be performed by power consumption management server 404 of power consumption management system 400 (shown in FIG. 4).

In the exemplary embodiment, process 900 includes receiving 902 from the at least one gaming device, user engagement data. The user engagement data indicates user engagement with at least one gaming device when operating according to one or more energy profiles.

The user engagement data may include gameplay data, such as bet amounts, number of game plays, length of gaming sessions by individual users, etc. that are provided from the gaming devices 104 to the server 404. The user engagement data may include gameplay data, such as bet amounts, number of game plays, length of gaming sessions by individual users, etc. that are provided from the gaming devices 104 to the server 404.

In the exemplary embodiment, energy profiles 414 may identify specific gaming devices 104 and/or other on-site devices 410 to be controlled and specific control operations for each of the identified specific gaming devices 104 and/or other on-site devices 410 that cause gaming devices 104 and/or other on-site devices 410 to reduce power consumption. Each energy profile may also be associated with a certain amount of power consumption reduction. For example, if a power reduction command is received specifying that a ten percent reduction in power is needed, an energy profile 414 corresponding to a ten percent reduction in power may be selected. Additionally or alternatively, one or more of the energy profiles 414 may be associated with a same amount of reduction in power consumption, but may control gaming devices 104 and/or other on-site devices 410 differently to achieve the reduction in power consumption.

In the exemplary embodiment, process 900 may further include updating 904 the predictive model based on the user engagement data. The predictive model may include a machine learning algorithm and/or artificial intelligence model that is configured to “learn” how different energy profiles and site conditions affect user engagement with gaming devices.

In the exemplary embodiment, process 900 may further include executing 906 the predictive model to identify a first energy profile. In some embodiments, the execution of the predictive model may be performed in response to a request to reduce power consumption of the gaming environment 402 by a certain amount and/or percentage. The predictive model 416 generate estimates of how certain energy profiles 414 that achieve the requested reduction in power consumption are likely to impact user engagement and select the energy profile 414 which maximizes player engagement. In addition to the requested power reduction, the predictive model may also receive as an input site data, such as a current time (e.g., of day, week, or year), current weather and/or temperature, current occupancy of electronic gaming environment 402, occupancy of any hotels, restaurants, parking structures, and/or other businesses associated with electronic gaming environment 402, whether any events (e.g., shows, concerts, sporting events, and/or conventions) are scheduled near electronic gaming environment 402, a current amount of power available from on-site power generation 412, and/or any other types of data that may relate to power consumption of electronic gaming environment 402 and/or outcomes of reducing a power consumption of electronic gaming environment 402 (e.g., whether such changes may be noticed by individuals present within electronic gaming environment 402).

In the exemplary embodiment, process 900 may further include controlling 908 the at least one gaming device to operate according to the first energy profile. In some embodiments, different energy profiles may be selected for different subsets of gaming devices in gaming environment 402, based on the predicted impact of the profiles on user engagement. Additionally, after the gaming devices 104 are controlled according to the first energy profile, the server 404 may continue to receive user engagement data from the gaming devices. Predictive model 416 may compare the received user engagement data to the predictions and update the predictive model 416 based on differences between the received user engagement data and the predicted user engagement.

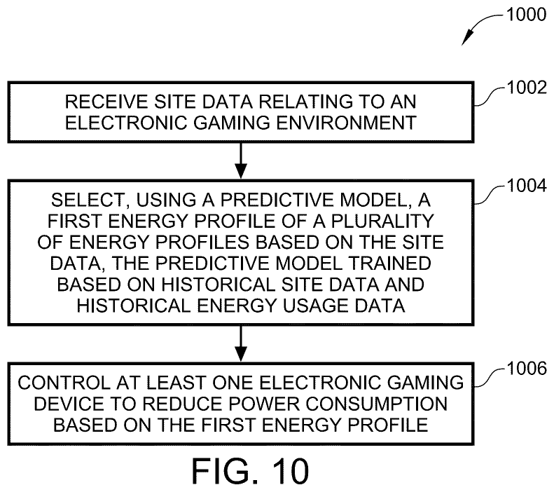

FIG. 10 is a flowchart illustrating an exemplary process 1000 for power consumption management for an electronic gaming environment such as electronic gaming environment 402. Process 1000 may be performed by power consumption management server 404 of power consumption management system 400 (shown in FIG. 4).

In the exemplary embodiment, process 1000 may include receiving 1002 site data relating to electronic gaming environment 402. This site data may include, for example, a current time (e.g., of day, week, or year), current weather and/or temperature, current occupancy of electronic gaming environment 402, occupancy of any hotels, restaurants, parking structures, and/or other businesses associated with electronic gaming environment 402, whether any events (e.g., shows, concerts, sporting events, and/or conventions) are scheduled near electronic gaming environment 402, a current amount of power available from on-site power generation 412, and/or any other types of data that may relate to power consumption of electronic gaming environment 402 and/or outcomes of reducing a power consumption of electronic gaming environment 402 (e.g., whether such changes may be noticed by patrons of electronic gaming environment 402).

In the exemplary embodiment, process 1000 may further include selecting 1004, using predictive model 416, a first energy profile 414 of the plurality of energy profiles 414 based on the site data. Predictive model 416 may be, for example, a machine learning and/or artificial intelligence model trained based on historical site data and associated outcomes, such as historical power consumption data, historical execution of control operations to reduce power consumption, feedback from customers and/or operators, and/or other factors that may be influenced by such site data and/or execution of control operations to reduce power consumption.

In the exemplary embodiment, process 1000 may further include controlling 1006 at least one electronic gaming device 104 and/or other on-site device 410 to reduce power consumption based on the first energy profile. For example, the first energy profile may specify that certain control operations be performed, including for example, deactivating and/or placing in a low-power (i.e., “sleep”) mode certain gaming devices 104 and/or other on-site devices 410, deactivating and/or placing in a low-power mode certain peripheral devices of gaming devices 104 (e.g., bill validator 124, printer 126, and/or any other auxiliary devices of gaming devices 104), deactivating, dimming, or adjusting a duty cycle of lighting (i.e., having a light source be lit some fraction of a second), adjusting (e.g., dimming or at least partially turning off) signage of gaming devices 104, adjusting game displays of gaming devices 104 (e.g., substituting default display outcomes with less energy intense display outcomes, such as ones including fewer animations or static displays), identifying zones (e.g., those with lower occupancy) of electronic gaming environment 402 in which certain power reduction actions can be taken, and/or other ways of reducing power.

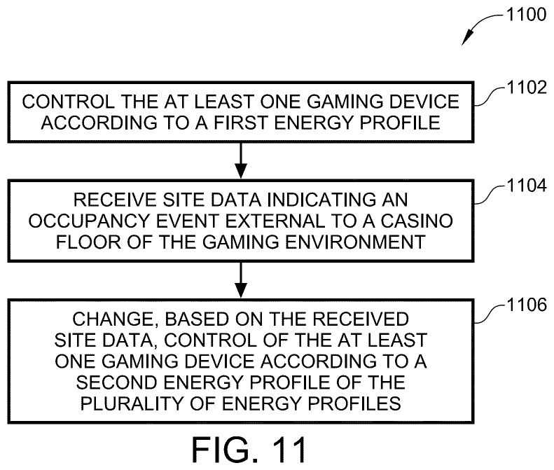

FIG. 11 is a flowchart illustrating an exemplary process 1100 for power consumption management of a gaming environment, such as gaming environment 402 (shown in FIG. 4). Process 1100 may be performed by power consumption management server 404 of power consumption management system 400 (shown in FIG. 4).

In the exemplary embodiment, process 1100 includes controlling 1102 at least one gaming device according to a first energy profile of the plurality of energy profiles.

In the exemplary embodiment, energy profiles 414 may identify specific gaming devices 104 and/or other on-site devices 410 to be controlled and specific control operations for each of the identified specific gaming devices 104 and/or other on-site devices 410 that cause gaming devices 104 and/or other on-site devices 410 to reduce power consumption.

Each energy profile may also be associated with a certain amount of power consumption reduction. For example, if a power reduction command is received specifying that a ten percent reduction in power is needed, an energy profile 414 corresponding to a ten percent reduction in power may be selected. Additionally or alternatively, one or more of the energy profiles 414 may be associated with a same amount of reduction in power consumption, but may control gaming devices 104 and/or other on-site devices 410 differently to achieve the reduction in power consumption.

In the exemplary embodiment, the first energy profile provides a reduced power consumption, relative to a second energy profile. The first energy profile may be used when the occupancy and/or predicted occupancy of the casino floor is at or below a certain threshold and the second energy profile may be used when the occupancy and/or predicted occupancy of the casino floor is above the threshold.

In the exemplary embodiment, process 1100 may further include receiving 1104 site data indicating an occupancy event external to a casino floor of the gaming environment. The external occupancy event data may be captured by one or more external sensors, such as proximity sensors or ingress/egress sensors in a parking garage and/or may include scheduled event data, such as a schedule for a nearby concert. An example occupancy event indicated by the site data may be include, for example and without limitation, an occupancy of any hotels, restaurants, parking structures, and/or other businesses associated with electronic gaming environment 402, whether any events (e.g., shows, concerts, sporting events, and/or conventions) are scheduled near electronic gaming environment 402, a detected movement or location of individuals within a building including the casino and/or adjacent buildings (e.g., by tracking elevator calls, door ingress/egress, image recognition of security video, vehicle traffic monitoring, and/or data traffic monitoring of a wireless network). The external event site data may be collected at the occupancy hub 420 and provided to the server 404 by the hub 420.

In the exemplary embodiment, process 1100 may further include changing 1106, based on the received site data, control of the at least one gaming device according to a second energy profile of the plurality of energy profiles. In the exemplary embodiment, the change increases a power consumption of one or more gaming devices to accommodate the increased occupancy of the casino floor that is likely to occur based on the site data. Moreover, the change may occur before the occupancy floor of the casino floor actually changes, such that newly arriving players may be presented with the casino floor operating according to the increased power consumption energy profile upon entering.

For example, during normal or low occupancy operation, a casino floor may be operated according to a low power consumption energy profile, in which one or more attract features of the gaming devices have a reduced brightness and/or several gaming devices are put into a “sleep mode,” in which the main displays are inactive (dimmed or black) until a user engages with or is otherwise detected at the machines. In one example, the server 404 may receive site data in the form of data from sensors in a parking garage of the casino that detect entry of vehicles into the parking garage. For example, at least some parking garages at casinos may include parking space occupancy sensors, proximity sensors or gate sensors that detect and track a number of cars in the parking garage and/or on different levels of the parking garage. In response to detecting, over a relatively short period of time, an increase in the level of parking garage occupancy and/or in response to the parking garage occupancy exceeding a threshold, server 404 may change control of one or more of the gaming devices 104 on the casino floor to a higher energy consumption energy profile, bringing the gaming devices out of sleep mode and/or activating/increasing power consumption of certain attract features of the gaming devices 104.

In some embodiments, server 404 may control subsets of gaming devices 104 on the casino floor based on one or more of a location of the gaming devices and an occupancy event that is indicated by the site data. For example, a casino floor may have multiple ingress points that are near different groupings of gaming devices 104 and server 404 may first increase power consumption for gaming devices 104 that are nearest to an ingress point that is likely to be most heavily trafficked based on the external occupancy event. In a simplified example, a casino floor may include a first ingress point near the front of the casino, which is the closest accessible for hotel guests or foot traffic from off the street. The casino floor may also include a second ingress point near a rear of the casino that is adjacent to a parking garage of the casino. If the site data indicates a sudden rise in the parking garage occupancy, the server 404 may take gaming devices out of sleep mode that are positioned adjacent to the second ingress point, and may thereafter rollout the increased energy profiles to other gaming devices on the floor. Alternatively, if the site data received at the server indicates a sudden rise in off-street foot traffic, through building door sensors and/or due to a scheduled nearby event ending, the gaming devices near the first ingress point may be first powered up. As a result, the change in energy profiles may be controlled such that incoming groups of players to the casino are likely to first see the devices that have already been adjusted to reflect the increased occupancy, thereby providing additional time to roll out the change in energy profiles to other gaming devices in areas of the casino floor less likely to be immediately heavily trafficked.

In some embodiments, process 1100 may further include determining, using the predictive model, a predicted occupancy of the casino floor based on the site data and the second energy profile may be selected based on the determined predicted occupancy. As an example, the predictive model may be trained by comparing the site data and predicted occupancy to actual occupancy data, captured for example by ingress/egress sensors to the casino floor, game use data, bet data, etc. As an example, in response to receiving site data indicating a 30% rise in parking garage occupancy within thirty minutes, predictive model may predict that a predicted occupancy of the casino floor is likely to be 20% higher than current occupancy. That is, despite there being a correspondence between the change in parking lot occupancy and casino occupancy, the change in parking lot occupancy may not necessarily produce a corresponding change in casino occupancy. For example, at least some of people parking a car in the parking lot may not be intending to visit the casino floor and/or a number of people arriving per vehicle parked may vary based on other variables, such as time of day, other events, weather, etc. In the example embodiment, predictive model is configured to continuously learn how other of the above-described site conditions impact the correlation between changes in parking lot occupancy, or any other external occupancy event, and actual change in casino floor occupancy and thereby improve predictions of expected occupancy based on the site data.

While the disclosure has been described with respect to the figures, it will be appreciated that many modifications and changes may be made by those skilled in the art without departing from the spirit of the disclosure. Any variation and derivation from the above description and figures are included in the scope of the present disclosure as defined by the claims.

What is claimed is:

1. A system for power consumption management for an electronic gaming environment, the system comprising:
at least one memory device with instructions stored thereon, the at least one memory device further storing a plurality of energy profiles, each of the energy profiles defining a set of control operations for at least one electronic gaming device; and
at least one processor in communication with the at least one memory device, wherein the instructions, when executed by the at least one processor, cause the at least one processor to:
receive a power adjustment command;
select, based on the power adjustment command, a first energy profile of the plurality of energy profiles; and
control the at least one electronic gaming device to adjust power consumption based on the first energy profile.

2. The system of claim 1, wherein the power adjustment command specifies an amount of reduction in power.

3. The system of claim 1, wherein each of the plurality of energy profiles corresponds to a respective amount reduction in power, and wherein the first energy profile is selected based on the amount of reduction in power specified by the power reduction command.

4. The system of claim 1, wherein the power adjustment command is received from a smart grid system.

5. The system of claim 1, wherein the memory further stores a predictive model, and wherein the instructions, when executed by the at least one processor, cause the at least one processor to:
receive, from the at least one electronic gaming device, user engagement data, the user engagement data indicating user engagement with the at least one electronic gaming device when operating according to one or more energy profiles of the plurality of energy profiles;
update the predictive model based on the user engagement data; and
execute the predictive model, wherein selection of the first energy profile is based on the execution of the predictive model.

6. The system of claim 5, wherein the user engagement data includes at least one of total bet amounts received at the at least one electronic gaming device, a number of game plays at the at least one gaming device, and a time of game play at the at least one gaming device.

7. The system of claim 5, wherein executing the predictive model includes:
generating a predicted user engagement for the at least one electronic gaming device for each energy profile of the plurality of energy profiles; and
determining that the first energy profile has a highest predicted user engagement of the plurality of energy profiles.

8. The system of claim 1, wherein the memory further stores a predictive model trained based on historical site data and historical energy usage data, and wherein the instructions, when executed by the at least one processor, cause the at least one processor to:
receive site data relating to the electronic gaming environment; and
execute the predictive model using the received site data, wherein the first energy profile is selected based on the execution of the predictive model.

9. The system of claim 8, wherein the site data includes at least two or more of time, weather, occupancy, and event schedules of the electronic gaming environment.

10. The system of claim 1, wherein to control the at least one electronic gaming device to adjust power consumption based on the first energy profile, the at least one processor is configured to cause the electronic gaming device to deactivate, dim, or adjust a duty cycle of lighting of the electronic gaming device.

11. The system of claim 1, wherein to control the at least one electronic gaming device to adjust power consumption based on the first energy profile, the at least one processor is configured to cause a game display of the electronic gaming device to be adjusted.

12. The system of claim 1, wherein to control the at least one electronic gaming device to adjust power consumption based on the first energy profile, the at least one processor is configured to cause at least one peripheral device of the electronic gaming device to deactivate or operate in a low-power mode.

13. The system of claim 1, wherein the instructions, when executed by the at least one processor, cause the at least one processor to:
receive site data indicating an occupancy event external to a casino floor of the gaming environment; and
change, based on the received site data, control of the at least one electronic gaming device according to a second energy profile of the plurality of energy profiles.

14. The system of claim 13, wherein changing control of the at least one gaming device according to the second energy profile increases power consumption of the at least one gaming device.

15. The system of claim 13, wherein the at least one memory stores a predictive model, and wherein the instructions, when executed by the at least one processor, further cause the at least one processor to:
determine, using the predictive model, a predicted occupancy of the casino floor based on the site data; and
select the second energy profile based on the determined predicted occupancy.

16. The system of claim 15, wherein the instructions, when executed by the at least one processor, further cause the at least one processor to:
receive additional site data indicating an occupancy of the casino floor;
compare the occupancy of the casino floor to the predicted occupancy of the casino floor; and
update the predictive model based on the comparison.

17. A non-transitory computer-readable medium, readable by a processor and comprising instructions stored thereon that, when executed, cause the processor to:
receive a power adjustment command;
select, based on the power adjustment command, a first energy profile of a plurality of energy profiles stored on the medium, each of the energy profiles defining a set of control operations for at least one electronic gaming device; and
control the at least one electronic gaming device to adjust power consumption based on the first energy profile.

18. The non-transitory computer-readable medium of claim 17, wherein the power adjustment command specifies an amount of reduction in power.

19. The non-transitory computer-readable medium of claim 17, wherein each of the plurality of energy profiles corresponds to a respective amount of reduction in power, and wherein the first energy profile is selected based on the amount of reduction in power specified by the power reduction command.

20. A method for managing power consumption of a gaming device, said method comprising:
receiving a power adjustment command;
selecting, based on the power adjustment command, a first energy profile of a plurality of energy profiles, wherein each of the energy profiles defines a set of control operations for the gaming device; and
controlling the gaming device to adjust power consumption based on the first energy profile.
